(19) United States
(12) Patent Application Publication
(10) Pub. No.: US 2016/0267445 A1
(43) Pub. Date: Sep. 15, 2016

(54) MANAGING ACCOUNTS AND TRANSACTIONS FOR REAL AND VIRTUAL CURRENCIES

(71) Applicant: Nelfor S.A., Montevideo (UY)

(72) Inventor: Federico Nano, Buenos Aires (AR)

(73) Assignee: Nelfor S.A., Montevideo (UY)

(21) Appl. No.: 14/645,187

(22) Filed: Mar. 11, 2015

(51) Int. Cl. G06Q 20/06; G06Q 20/10

(52) U.S. Cl. CPC G06Q 20/065; G06Q 20/10

(57) ABSTRACT

A method including receiving currency settings from each of two or more issuers. Each of the two or more issuers can issue a different currency. The currency settings for at least one of the two or more issuers can include settings for a virtual currency. The method also can include creating accounts for each of the two or more issuers. The accounts for each of the two or more issuers can be configured to use the currency issued by the issuer. The accounts for each of the two or more issuers can include an issuer account. The accounts for each of the two or more issuers also can include one or more customer accounts associated with customers of the issuer. Balances of the accounts can be stored in a database. The method additionally can include receiving a transaction request. The method further can include processing the transaction request. Processing the transaction request can include decrementing in the database a first balance of a first account. Processing the transaction request also can include incrementing in the database a second balance of a second account. The accounts can include the first account and the second account. The first account can be different from the second account. Other embodiments are provided.

### TECHNICAL FIELD

This disclosure relates generally to account management for transactions, and relates more particularly to systems and methods for managing accounts for real and/or virtual currencies and managing transactions among those accounts.

### BACKGROUND

Various companies reward consumers for purchasing products, utilizing their services, providing information, or other actions by providing virtual currency, such as rewards points (also known as loyalty points), miles, or other credits. Each issuer of virtual currency generally faces the challenge of managing the virtual currency and any transactions, such as redemption transactions. These virtual currencies are often non-negotiable, and can generally be redeemed only through the issuer of the virtual currency or others authorized by the issuer.

### BRIEF DESCRIPTION OF THE DRAWINGS

To facilitate further description of the embodiments, the following drawings are provided in which:

FIG. 1 illustrates a block diagram of an exemplary system, according to an embodiment;

FIG. 2 illustrates a chart showing accounts for issuers, with various currencies, which can be managed using the transaction system of FIG. 1;

FIG. 3 illustrates a diagram of visibility scopes for accounts in the transaction system of FIG. 1;

FIG. 4 illustrates a block diagram of transaction flows for transactions units sent from issuer systems to the transaction system of FIG. 1;

FIG. 5 illustrates a block diagram of transaction flows for a transactions unit sent from an issuer system to the transaction system of FIG. 1 and involving the issuer scope of a different issuer operating a different issuer system;

FIG. 6 illustrates a flow chart for a method for facilitating transactions, according to another embodiment;

FIG. 7 illustrates a computer system that is suitable for implementing an embodiment of at least a portion of various elements of the system of FIG. 1; and

FIG. 8 illustrates a representative block diagram of an example of elements included in circuit boards inside a chassis of the computer of FIG. 7.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a method for facilitating transactions. The method can be implemented via execution of computer instructions configured to run at one or more processing modules and configured to be stored at one or more non-transitory memory storage modules. The method can include receiving currency settings from each of two or more issuers. Each of the two or more issuers can issue a different currency. The currency settings for at least one of the two or more issuers can include settings for a virtual currency. The method also can include creating accounts for each of the two or more issuers. The accounts for each of the two or more issuers can be configured to use the currency issued by the issuer. The accounts for each of the two or more issuers can include an issuer account. The accounts for each of the two or more issuers also can include one or more customer accounts associated with customers of the issuer. Balances of the accounts can be stored in a database. The method additionally can include receiving a transaction request. The method further can include processing the transaction request. Processing the transaction request can include decrementing in the database a first balance of a first account. Processing the transaction request also can include incrementing in the database a second balance of a second account. The accounts can include the first account and the second account. The first account can be different from the second account.

A number of embodiments can include a system for facilitating transactions. The system can include one or more processing modules and one or more non-transitory memory storage modules storing computing instructions configured to run on the one or more processing modules and perform various acts. The acts can include receiving currency settings from each of two or more issuers. Each of the two or more issuers can issue a different currency. The currency settings for at least one of the two or more issuers can include settings for a virtual currency. The acts also can include creating accounts for each of the two or more issuers. The accounts for each of the two or more issuers can be configured to use the currency issued by the issuer. The accounts for each of the two or more issuers can include an issuer account. The accounts for each of the two or more issuers also can include one or more customer accounts associated with customers of the issuer. Balances of the accounts can be stored in a database. The acts additionally can include receiving a transaction request. The acts further can include processing the transaction request. Processing the transaction request can include decrementing in the database a first balance of a first account. Processing the transaction request also can include incrementing in the database a second balance of a second account. The accounts can include the first account and the second account. The first account can be different from the second account.

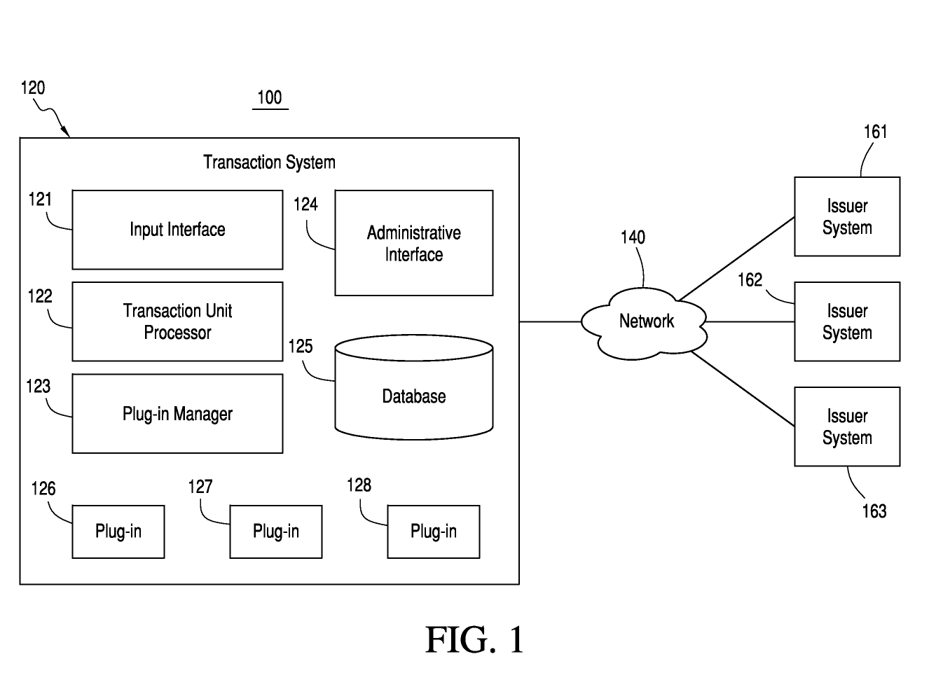

Turning to the drawings, FIG. 1 illustrates a block diagram of an exemplary system 100, all or portions of which can be employed for facilitating transactions, according to an embodiment. System 100 is merely exemplary, and embodiments of the system are not limited to the embodiments presented herein. The system can be employed in many different embodiments or examples not specifically depicted or described herein. In some embodiments, certain elements or modules of system 100 can perform various procedures, processes, and/or activities. In other embodiments, the procedures, processes, and/or activities can be performed by other suitable elements or modules of system 100.

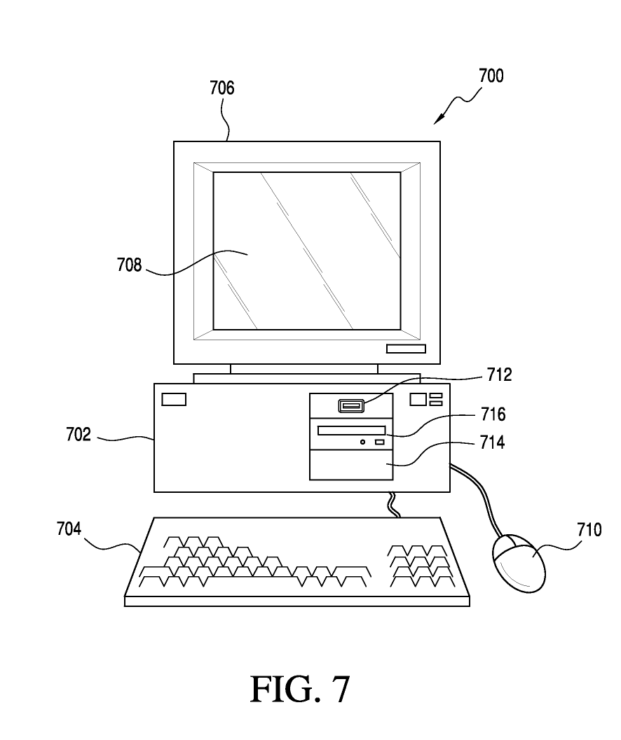

In many embodiments, system 100 can include a transaction system 120, a network, and/or one or more issuer systems (e.g., 161-163). In a number of embodiments, transaction system 120 can be all or a portion of, reside on, and/or operate on a computer system, such as computer system 700 (FIG. 7), as described below, which can be a single computer, a single server, a cluster or collection of computers or servers, or a cloud of computers or servers. For example, in some embodiments, transaction system 120 can be a stand-alone system. In other embodiments, transaction system 120 can be part of a larger system, such as one or more modules of a larger system.

In a number of embodiments, the issuer systems (e.g., 161-163) can each be operated by an business. In several embodiments, each business can be an issuer, such as an issuer of virtual currency, or a business that offers, trades, exchanges, maintains, and/or tracks goods, services, virtual or real currencies, etc. In various embodiments, an issuer can be a business, a business division, a brand, a person, an organization, etc. In a number of embodiments, the issuer systems (e.g., 161-163) can be tablet computing devices, smart phones, laptop computers, desktop computers, servers, and/or other devices, and can be similar or identical to computer system 700 (FIG. 7), as described below. In many embodiments, the one or more issuer systems (e.g., 161-163) can be in data communication with transaction system 120 through network 140. In a number of embodiments, network 140 can be a local area network (LAN), a wireless LAN, a wide area network (WAN), a mobile telecommunications wireless data network, the Internet, another suitable network, or a combination thereof. In some embodiments, one or more of the issuer systems (e.g., 161-163) and transaction system 120 can be and/or operate on the same device. In other embodiments, one or more of the issuer systems (e.g., 161-163) and transaction system 120 can be and/or operate on different devices, as shown in FIG. 1.

In several embodiments, transaction system 120 can be an engine, such as a geospatial or other engine, configured to work with multiple accounts and currencies to facilitate the exchange of goods between individuals and/or entities. In several embodiments, transaction system 120 can facilitate acquiring information about interactions, such as transactional interactions, between the individuals and/or entities. In several embodiments, each of the individuals and/or entities can have a social user profile that is common across the accounts of the individual or entity. In many embodiments, transaction system 120 can provide be configured to incorporate and/or model various different business, such as financial, stock, health, loyalty, and/or accounting businesses, which can offer, trade, exchange, maintain, and/or track goods, services, virtual or real currencies, etc. For example, using transaction system 120, a health company can trade services for a medical procedure in exchange for loyalty points accumulated from a different business. In many embodiments, transaction system 120 can be scalable to grow and develop businesses.

In many embodiments, transaction system 120 can be based on a simplified data model, which can be configured to execute simple, specific, configurable, and/or atomic operations. In several embodiments, an account holder can have multiple accounts and/or currencies, can exchange values between accounts held by the same account holder, and/or can exchange with other accounts of other account holders. In various embodiments, transaction system 120 can provide a network exchange, which can integrate various different business. In several embodiments, transaction system 120 can provide functionality to be integrated with rules of various different business, which can advantageously allow transaction system 120 to be adapted to any product and/or business. In several embodiments, transaction system 120 can provide management of the accounts, currencies, and/or entities. In some embodiments, transaction system 120 can collect and generate information about the businesses and customers of the business that use transaction system 120. In several embodiments, transaction system 120 can track where transactions occur and/or are initiated in the world. In a number of embodiments, transaction system 120 can provide the location information about transactions to the businesses, such as in real time. In several embodiments, a business can use transaction system 120 to configure a community of customers. In some embodiments, transaction system 120 can provide default business models for rapid setup and/or configuration. In the same or other embodiments, transaction system 120 can provide extended functionality to provide flexibility for businesses beyond the default business models.

In several embodiments, transaction system 120 can provide accounts for the issuers, such as the businesses, and for customers of the issuers. In many embodiments, each account in transaction system 120 can have an account holder, such as the issuer or the customer of the issuer. In several embodiments, account holders can have accounts with one or more issuers. In a number of embodiments, each account holder registered in transaction system 120 can have a unique identifier, such as an email address or another unique identifier, which can provide the ability to identify the account holder globally, such that when the account holder with an issuer is registered for a new account with a different issuer, transaction system 120 can link the account holder to both issuers, which can beneficially avoid duplicates in transaction system 120.

In many embodiments, transaction system 120 can include an input interface 121, a transaction unit processor 122, a plug-in manager 123, an administrative interface 124, a database 125, and/or one or more plug-ins (e.g., 126-128). In a number of embodiments, input interface 121 can provide a gateway for using and accessing the functionality of transaction system 120. In several embodiments, interface 121 can provide methods to execute internal transactions and can provide extended methods via a set of protocols. In various embodiments, input interface 121 (FIG. 1) can provide an application programming interface (API). In some embodiments, the API can use the REST (Representation State Transfer) protocol, SOAP (Simple Object Access Protocol), HL7 (Health Level 7), ISO 8583 (International Organization for Standardization 8583 for financial transaction card originated messages), and/or other suitable protocols. In some embodiments, the protocols can be added or removed, such as in an extensible manner, as needed. In many embodiments, one or more of the issuer systems (e.g., 161-163) can use input interface 121 to request the transactions, as transaction units, to be processed in transaction system 120. In some embodiments, input interface 121 can provide a user interface, which can be presented through a network-based server, such as through a web browser.

In some embodiments, transaction unit processor 122 can process the transaction units received through input interface 121. In some embodiments, the transaction flows can be constructed via primitive instructions defined by a core of transaction unit processor 122. In a number of embodiments, the transaction flows can be extended functions provided through plug-ins, such as through macro calls. In some embodiments, transaction units can be written using a scripting language, such as the Lua language, which can combine simple procedural syntax with powerful data description constructs based on associative arrays and extensible semantics, can be dynamically typed, can run by interpreting byte code for a register-based virtual machine, and can have automatic memory management with incremental garbage collection, which can beneficially facilitate configuration, scripting, and rapid prototyping. In other embodiments, transaction units can be defined using other suitable mechanisms. In some embodiments, transaction unit processor 122 can audit the actions executed in a transaction unit, which can track each operation.

In various embodiments, plug-in manager 123 can manage the extensibility of transaction system 120 through the plug-ins (e.g., 126-128). In many embodiments, plug-in manager 123 and the plug-ins (e.g., 126-128) can allow transaction system 120 to grow and adapt to a wide range of needs for various types of businesses. In some embodiments, there can be a number of predefined plug-in interfaces for the plug-ins (e.g., 126-128), such as a base plug-in interface, which can allow creating new plug-ins (e.g., 126-128) for specific businesses via a general purpose extension. In many embodiments, the plug-ins (e.g., 126-128) can be functional modules that can extend core functionality, such as to provide specific implementation for custom functionality. For example, an account management plugin can be defined, which can provide a basic implementation for financial accounts and operations. As the business evolves, the account management plugin can be changed for another more robust and complete implementation for banking account management. The definitions of each plug-in (e.g., 126-128) can define its purpose according to the specific business needs, which can advantageously give flexibility and the capacity of adaptation to businesses using transaction system 120.

In some embodiments, the plug-ins (e.g., 126-128) can add functionary in one or more ways. For example, in many embodiments, the plug-ins (e.g., 126-128) can add functionality as transaction unit macros, which can add functions used as primitive methods within the definition of a transaction unit. In several embodiments, the plug-ins (e.g., 126-128) can add functionality as interface direct methods, which can allow a method defined within the plug-in (e.g., 126-128) to be exposed directly as a core service that can be executed directly through input interface 121, such as an account balance method. In various embodiments, the plug-ins (e.g., 126-128) can add functionality as an administrative configuration add-in, which can extend administrative interface 124, described below, with sections or pages to configure settings to facilitate operation and or the proper functioning of one or more plug-ins (e.g., 126-128).

In many embodiments, administrative interface 124 can provide a console to facilitate an administrator of transaction system 120, such as an issuer and/or a super user, to configure, maintain, and/or track the system health and operative status of transaction system 120. In some embodiments, administrative interface 124 can track activity and/or data, such as accounts, currencies, account holders, and/or transactions. In many embodiments, administrative interface 124 can allow the administrator to see when transactions are executed in the system, and can provide auditing information to troubleshoot possible issues. In some embodiments, administrative interface 124 can be extended by one or more of the plug-ins (e.g., 126-128) to show specific configurations for the plug-ins (e.g., 126-128). In some embodiments, administrative interface 124 can provide a user interface, which can be presented through a network-based server, such as through a web browser. In other embodiments, administrative interface can be a remote client application, a stand-alone application, or another suitable interface.

In many embodiments, database 125 can store the data, such as accounts, currencies, account holders, and/or transaction records. In a number of embodiments, database 125 can be an ORM (object-relational mapping) DBMS (database management system) data access component, which can manage a data persistence model. In other embodiments, other mechanisms can be used. In several embodiments, the data model in database 125 can be extended via plug-ins (e.g., 126-128), which can define new entities for storage and/or management.

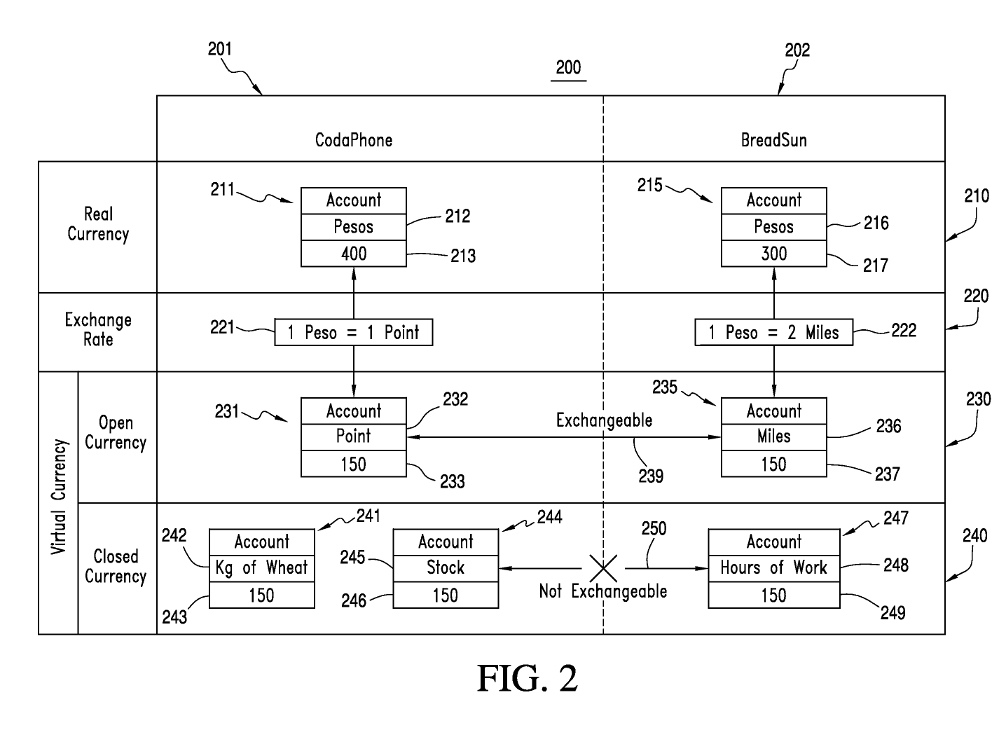

Turning ahead in the drawings, FIG. 2 illustrates a chart showing accounts 200 for an issuer 201 and an issuer 202, with various currencies, which can be managed using transaction system 120 (FIG. 1), according to an embodiment. Issuers 201 and 202 can access transaction system 120 (FIG. 1) through issuer systems (e.g., 161-163 (FIG. 1)). Accounts 200 are merely exemplary, and embodiments provided by the transaction system 120 (FIG. 1) can be employed in many different embodiments or examples not specifically depicted or described herein. In the example shown in FIG. 2, issuer 201 can be a business named CodaPhone, and issuer 202 can be a business named BreadSun. In a number of embodiments, issuer 201 can have accounts, such as account 211, account 231, account 241, and/or account 244, in transaction system 120 (FIG. 1). In many embodiments, issuer 202 can have accounts, such as account 215, account 235, and/or account 247, in transaction system 120 (FIG. 1). In many embodiments, each account can have a currency and an account balance. For example, account 211 can have a currency 212 of Pesos and a balance 213 of 400, account 215 can have a currency 216 of Pesos and a balance 217 of 300, account 231 can have a currency 232 of Point and a balance of 150, account 235 can have a currency 236 of Miles and a balance 233 of 150, account 241 can have a currency 242 of Kg (kilograms) of Wheat and a balance 243 of 150, account 244 can have a currency 245 of Stock and a balance 246 of 150, and/or account 247 can have a currency 248 of Hours of Work and a balance of 249. In some embodiments, the accounts can be issuer accounts, such that currency in the account can be owned by the issuer (e.g., 201, 202). In other embodiments, the accounts can be customer accounts, such that the accounts can be owned by customers of the issuer (e.g., 201, 202).

In a number of embodiments, currencies can be real currencies, such a fiat money (e.g., United States dollar (USD), Argentine peso (ARS), Chinese yuan (CNY), etc.). For example, the accounts shown in row 210, namely, account 211 and account 215, can use real currency (Pesos), as listed in currency 212 and currency 216. In some embodiments, currencies can be virtual currencies, which can be created by the issuer (e.g., 201, 202), which can have validity within the score of the issuer (e.g., 201, 202).

In some embodiments, virtual currencies can be open currencies, which can have an exchange rate with a real currency. For example, the accounts shown in row 230, namely, account 231 and account 235, can have an exchange rate with a real currency. For example, row 220 shows exemplary exchange rates 221 and 222. As shown in FIG. 2, exchange rate 221 can be that 1 Peso is equivalent to 1 Point. Based on exchange rate 221, currency 232 (Point) in account 231 can be exchanged with currency 212 (Pesos) in account 211. As shown in FIG. 2, exchange rate 222 can be that 1 Peso is equivalent to 2 Miles. Based on exchange rate 222, currency 236 (Miles) in account 235 can be exchanged with currency 216 (Peso) in Account 215. In many embodiments, an issuer (e.g., 201, 202) can define the exchange rates (e.g., 221, 222) for virtual currencies issued by the issuer (e.g., 232, 236). For example, when issuer 201 (CodaPhone) defines currency 232 as Point, issuer 201 can define exchange rate 221 as 1 Point being equivalent to 1 Peso. Similarly, when issuer 202 defined currency 236 as Miles, issuer 202 can define exchange rate 222 as 2 Miles being equivalent to 1 Peso.

In many embodiments, an open currency can be exchanged with open currencies issued by other issuers based on the exchange rates (e.g., 221, 222) with real currencies. For example, currency 232 (Points) issued by issuer 201 (CodaPhone) can be exchanged in an transaction 239 with currency 236 (Miles) issued by issuer 202 (BreadSun), as the common real currency of Pesos, in currencies 212 and 216, can be used to exchange 1 Point for 2 Miles. As real currencies have exchange rates based on market conditions, in several embodiments, open currencies can be exchanged even when they involve exchange rates having different real currencies. In some embodiments, a virtual currency can have no exchange rate with an real currency, but can have an exchange rate defined with an open currency, which can cause that virtual currency to function as an open currency, as it can be exchanged with a real currency based on the combination of its exchange rate with the open currency and the exchange rate of the open currency with the real currency.

In several embodiments, virtual currencies can be closed currencies, which can have no exchange rate with a real currency. For example, the accounts shown in row 240 can have no exchange rate with a real currency. For example, issuer 202 can define currency 242 of Kg of Wheat, but not define an exchange rate. Similarly issuer 202 can define currency 245 of Stock, but not define an exchange rate. As another example, issuer 202 can define currency 248 of Hours of Work, but not define an exchange rate. In several embodiments, closed currencies can be visible and/or exchangeable only within the scope of an issuer, such that the currency cannot be traded with currencies issued by other issuers. For example, in a transaction attempt 250 between currency 245 (Stock) issued by issuer 201 (CodaPhone) and currency 248 (Hours of Work) issued by issuer 202 (BreadSun), the currencies can be not exchangeable, as there are no real currencies on which to base the transaction. In some embodiments, an issuer, such as issuer 201, can define exchange rates between closed currencies, such as between currency 242 (Kg of Wheat) and currency 245 (Stock), but such exchanges can be limited to within the score of accounts for the same issuer (e.g., issuer 201).

In some embodiments, if the currency is a closed currency (e.g., 241, 244, 247), the issuer can add or remove points as needed. In such cases, the issuer can have complete control over the issuer account, the closed currency, and/or the manner in which the currency is distributed. In a number of embodiments, if the currency is an open currency, the issuer can be required to guarantee support for the currency at the defined exchange rate by backing it up with real currency. For example, account 231 can be an issuer account for issuer 210 (CodaPhone) having currency 232 of Point, which is an open virtual currency; and account 211 can be another issuer account for issuer 201 (CodaPhone) having currency 212 of Pesos, which is a real currency. In many embodiments, issuer 201 (CodaPhone) can be required to have sufficient real currency to support the amount of open virtual currency within the scope of issuer 201 (CodaPhone), based on the defined exchange rates (e.g., 221).

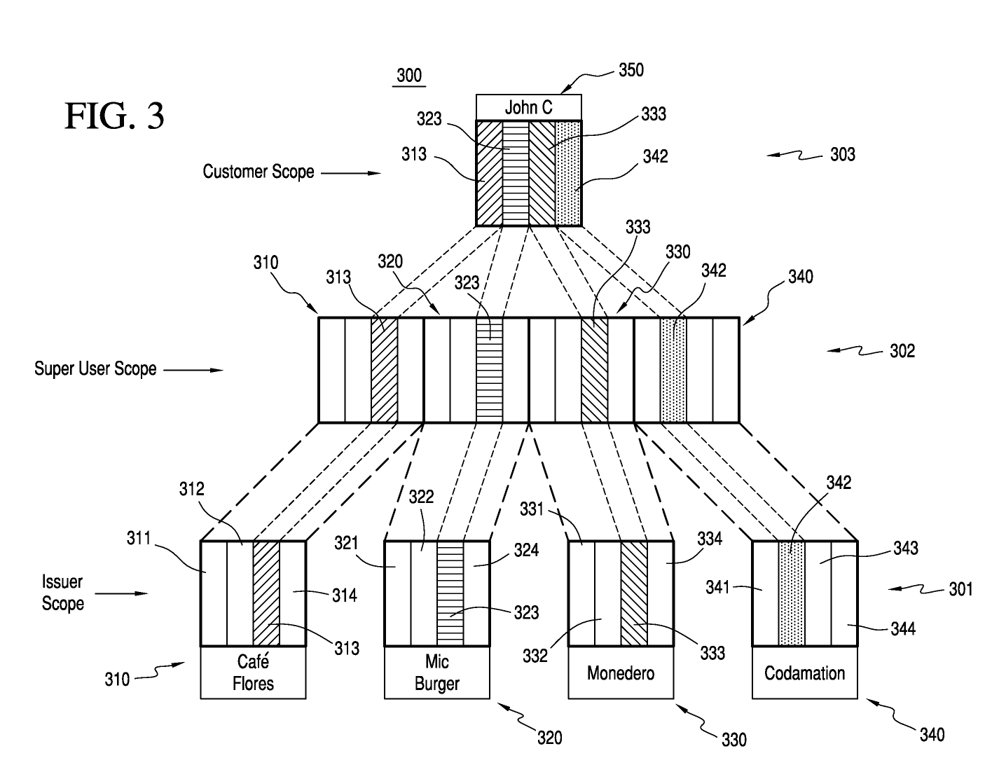

Turning ahead in the drawings, FIG. 3 illustrates a diagram of visibility scopes 300 for accounts in transaction system 120 (FIG. 1). Visibility scopes 300 are merely exemplary and are not limited to the embodiments presented herein. In many embodiments, different type of entities (e.g., issuers, customers, administrators) can have different visibility scopes, as shown in visibility scopes 300. In various embodiments, an account holder can access transaction system 120 to view all of the accounts of the account holder, and in some embodiments to see a full transaction history of all of the accounts of the account holder. In some embodiments, an issuer can have access only to the accounts that have been issued by the issuer, to the customers associated to those accounts, and the transactions involving those accounts. For example, in some embodiments, each issuer can have no knowledge of whether an account holder having an account with the issuer has a relationship or transactions with one or more other issuers.

In some embodiments, transaction system 120 (FIG. 1) can be used by various issuers, such as an issuer 310 named Café Flores, an issuer 320 named Mic Burger, an issuer 330 named Monedero, and/or an issuer 340 named Codamation. Issuer systems 310, 320, 33, 340 can access transaction system 120 (FIG. 1) through issuer systems (e.g., 161-163 (FIG. 1)). In some embodiments, each issuer (e.g., 310, 320, 330, 340) can use transaction system 120 to define one or more accounts, such as one or more issuer accounts and/or one or more customer accounts. For example, issuer 310 (Café Flores) can define accounts 311, 312, 313, and 314. Account 313 can be an account for a customer 350 named John C. As another example, issuer 320 (Mic Burger) can define accounts 321, 322, 323, and 324. Account 323 can be an account for customer 350 (John C). As yet another example, issuer 330 (Monedero) can define accounts 331, 332, 333, and 334. Account 333 can be an account for customer 350 (John C). As a further example, issuer 340 (Codamation) can define accounts 341, 342, 343, and 344. Account 342 can be an account for customer 350 (John C).

In a number of embodiments, an administrator (or super user) of transaction system 120 (FIG. 1) can have a super user scope 302, which can be able to access the accounts for all of the issuers (310, 320, 330, 340), that is the super user scope 302 can include access to accounts 311-314, 321-324, 331-334, and 341-344, which includes all of the accounts for customer 350 (John C), namely accounts 313, 323, 333, and 342. In many embodiments, the super user scope can allow the administrator of transaction system 120 to manage interrelationships between issuers, which can beneficially allow for interexchange between business systems.

In several embodiments, each issuer (e.g., 310, 320, 330, 340) can have an issuer scope 301, which for each issuer (e.g., 310, 320, 330, 340) can be the accounts for the issuer (e.g., 310, 320, 330, 340). For example, the issuer scope for issuer 310 (Café Flores) can be accounts 311, 312, 313, and 314, such that issuer 310 can access those accounts. Similarly, the issuer scope for issuer 320 (Mic Burger) can be accounts 321, 322, 323, and 324; the issuer scope for issuer 330 (Monedero) can be accounts 331, 332, 333, and 334; and the issuer scope for issuer 340 (Codamation) can be accounts 341, 342, 343, and 344. In many embodiments, an issuer can only access the accounts in the issuer scope for the issuer, and not the other accounts for other issuers. For example, issuer 310 (Café Flores) can access accounts 311-314, and cannot access accounts 321-324, 331-334, and 341-344.

In several embodiments, each customer, such as customer 350 (John C) can have a customer scope 303, which can be the accounts for which the customer is an account holder. For example, customer scope 313 for customer 350 (John C) can be accounts 313, 323, 333, and 342. In many embodiments, a customer having accounts with multiple issuers, such as customer 350, can access extensive information about the accounts for which the customer is the account holder, the transactions involving those accounts, and/or other operations involving those accounts or the customer, which can advantageously allow the user to be aware of the operative environment and accounts of the customer. In many embodiments, customer scope 313 for customer 350 (John C) does not allow customer 350 to view the accounts for other account holders (e.g., accounts 311-312, 314, 321-322, 324, 331-332, 334, 341, 343-344).

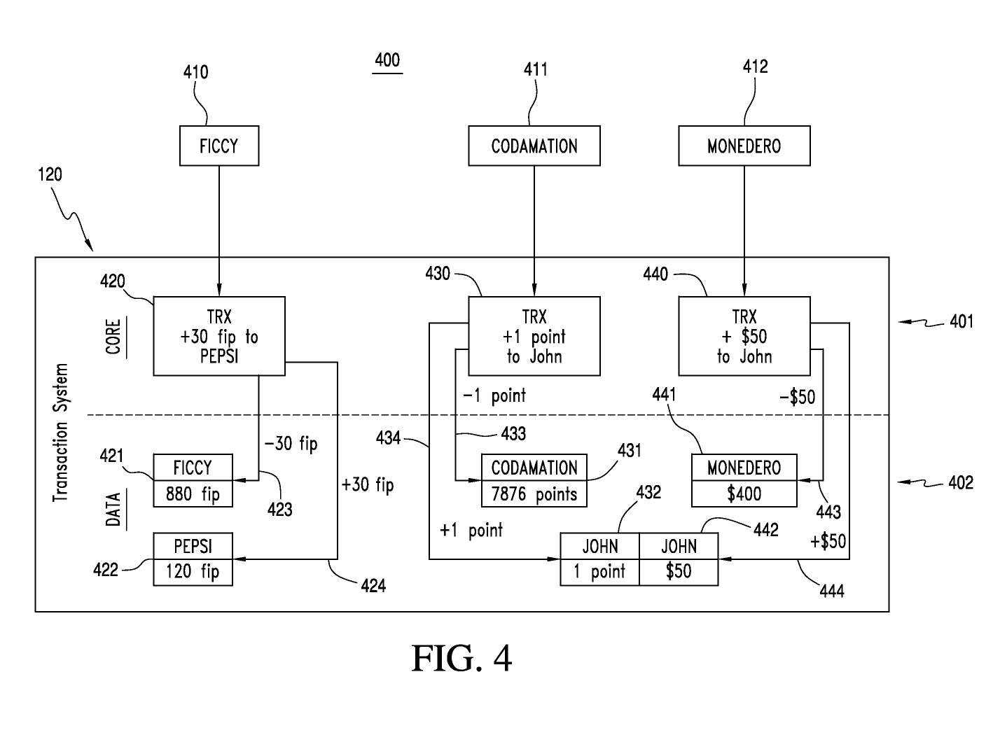

Turning ahead in the drawings, FIG. 4 illustrates a block diagram of transaction flows 400 for transactions units sent from issuer systems 410, 411, and 412 to transaction system 120. Transaction flows 400 are merely exemplary and are not limited to the embodiments presented herein. Issuer systems 410-412 can be similar or identical to issuer systems (e.g., 161-163 (FIG. 1)). In some embodiments, issuer system 410 can be operated by an issuer named Ficcy, which can be an advertising business; issuer system 411 can be operated by an issuer named Codamation, which can be a loyalty business; and/or issuer system 412 can be operated by an issuer named Monedero, which can be a mobile-wallet business.

In various embodiments, each issuer (e.g., Ficcy, Codamation, and/or Monedero) can begin using transaction system 120 by registering as an issuer with transaction system 120. Once registered with transaction system 120, each issuer can begin to define the tools and transaction types for its business. For example, each issuer can define the currencies, exchange rates, accounts, customer, etc. associated with the issuer. For example, the issuer can define and/or select one or more virtual and/or real currencies, such as open currencies or closed currencies. For example, the issuer can define the one or more virtual currencies that the business will use (e.g., points, miles, kg of wheat, hours of work, stock, etc.). The issuer can define exchange rates between the virtual currency and a real currency, which can allow for exchanges with real currencies and/or transactions that operate outside of the issuer scope (e.g., 301 (FIG. 3)) of the issuer. In some embodiments, the issuer can define a primary currency that can be used for internal transactions performed by the issuer, commissions, external exchanges, etc. For example, issuer Ficcy can use issuer system 410 to define a virtual currency in transaction system 120 named fip (Ficcy points), issuer Codamation can define a virtual currency of points, and/or issuer Monedero can select a real currency of dollars.

In some embodiments, an issuer can create default transactions, which can define the primitive business operations that can be carried out on its accounts in transaction system 120. These operations can include as many actions, validations, or flows as required by business needs. For example, issuer Ficcy can define a default transaction to transfer fip of a certain amount from an issuer account of Ficcy to a customer account of Ficcy upon a certain type of occurrence.

In a number of embodiments, the issuer can define the accounts within the issuer scope (e.g., 301 (FIG. 1)) of the issuer. For example, issuer Ficcy can use issuer system 410 to create an account 421 and an account 422 in transaction system 120. Account 421 can be an issuer account for Ficcy, and account 422 can be a customer account for a customer named Pepsi. As another example, issuer Codamation can use issuer system 411 to create an account 431 and an account 432 in transaction system 120. Account 431 can be an issuer account for Codamation, and account 432 can be a customer account for a customer named John. As yet another example, issuer Monedero can use issuer system 412 to create an account 441 and an account 442 in transaction system 120. Account 441 can be an issuer account for Monedero, and account 442 can be a customer account for the customer John, which is the same customer having a Codamation account. In many embodiments, the customers can be created in advance or during standard business operation, depending on the needs of the business.

In many embodiments, transaction system 120 can use the definitions of the business to facilitate, manage, track, and/or regulate transactions within the business or among different businesses. For example, issuer Ficcy can use issuer system 410 to add units of fip to account 421, which is its issuer account.

In many embodiments, when an issuer increments or decrements a customer account the issuer can decrement or increment, respectively, the issuer account accordingly. For example, issuer Ficcy can use issuer system 410 to send a transaction unit (TRX) 420 to transaction system 120 to add 30 fip to the customer account for Pepsi. In several embodiments, the transaction units can be a default transaction that is predefined by issuer Ficcy. In some examples, a default transaction can have a static value, such as 30 fip. In other examples, a default transaction can have a variable value defined in the transaction unit (e.g., 420). In a number of embodiments, transaction unit 420 can be processed in a core 401 of transaction system 120, such as transaction unit processor 122 (FIG. 1), and can affect data 402 in transaction system 120, such as data stored in database 125 (FIG. 1). In many embodiments, transaction unit 420 can be processed by an action 423 of decrementing 30 fip from account 421, which is the issuer account of issuer Ficcy, and an action 424 of incrementing 30 fip to account 422, which is the customer account of Pepsi for issuer Ficcy. For example, the 880 fip in account 421 can be decremented by 30 fip to 850 fip, and the 120 fip in account 422 can be incremented by 30 fip to 150 fip.

As another example, issuer Codamation can use issuer system 411 to send a transaction unit 430 to transaction system 120 to add 1 Point to the customer account for John. In a number of embodiments, transaction unit 430 can be processed by an action 433 of decrementing 1 Point from account 431, which is the issuer account of issuer Codamation, and an action 434 of incrementing 1 Point to account 433, which is the customer account of John for issuer Codamation. For example, the 7876 points in account 431 can be decremented by 1 point to 7875 points, and the 1 point in account 432 can be incremented by 1 point to 2 points.

As yet another example, issuer Monedero can use issuer system 412 to send a transaction unit 440 to transaction system 120 to add $50 to the customer account for John. In a number of embodiments, transaction unit 440 can be processed by an action 443 of decrementing $50 from account 441, which is the issuer account of issuer Monedero, and an action 444 of incrementing $50 to account 443, which is the customer account of John for issuer Monedero. For example, the $400 in account 441 can be decremented by $50 to $350, and the $50 in account 442 can be incremented by $50 to $100.

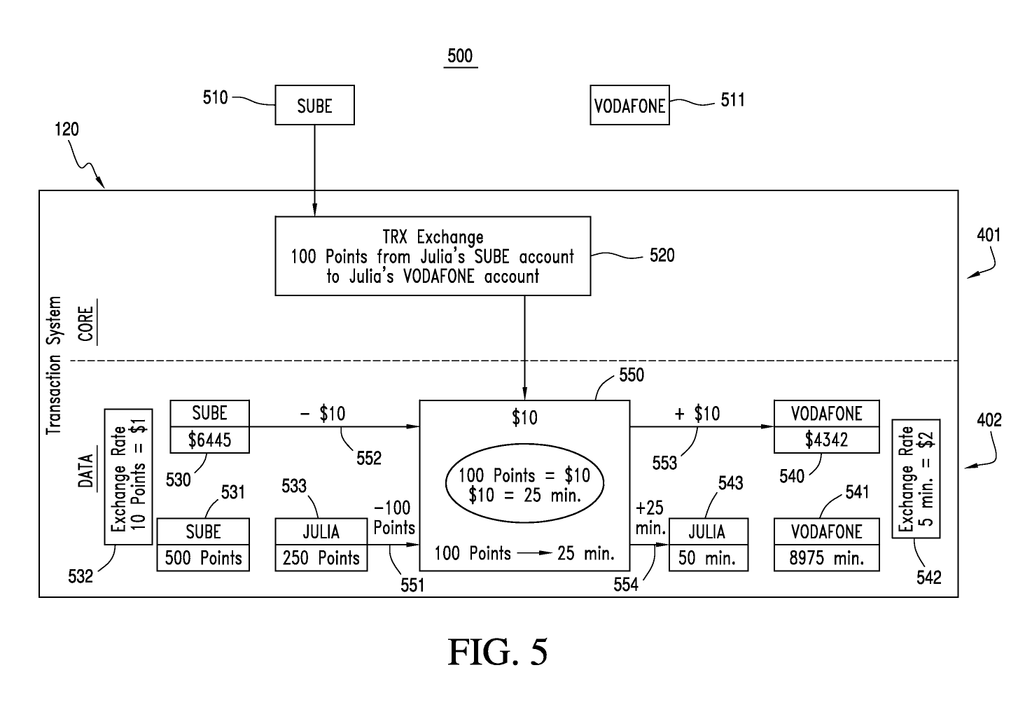

Turning ahead in the drawings, FIG. 5 illustrates a block diagram of transaction flows 500 for a transactions unit 520 sent from an issuer system 510 to transaction system 120 and involving the issuer scope of an issuer operating an issuer system 511. Transaction flows 500 are merely exemplary and are not limited to the embodiments presented herein. Issuer system 510 and issuer system 511 can be similar or identical to issuer systems (e.g., 161-163 (FIG. 1)) and/or issuer systems 410-412 (FIG. 4). In some embodiments, issuer system 510 can be operated by an issuer named Sube, which can be a public transport business; and/or issuer system 511 can be operated by an issuer named Vodafone, which can be a cellphone communications business.

In the example shown in FIG. 5, issuer Sube can use issuer system 510 to define in transaction system 120 an open currency named Points, and can define an exchange rate 532 that sets 10 Points as equivalent to $1. In several embodiments, issuer Sube can create account 530 and account 531, which can be issuer accounts of Sube. For example, account 530 can be an issuer account for real currency, and account 531 can be an issuer account for the open virtual currency, Points. In several embodiments, transaction system 120 can require issuer Sube to maintain a sufficient amount of real currency in account 530 to cover the open virtual currency, Points, in all the accounts in the issuer scope of issuer Sube. In many embodiments, issuer Sube can define an account 533 for a customer named Julia within the issuer scope of issuer Sube.

Continuing with the example shown in FIG. 5, issuer Vodafone can use issuer system 511 to define in transaction system 120 an open currency named minutes (min.), and can define an exchange rate 542 that sets 5 minutes as equivalent to $2. In several embodiments, issuer Vodafone can create account 540 and account 541, which can be issuer accounts of Vodafone. For example, account 540 can be an issuer account for real currency, and account 541 can be an issuer account for the open virtual currency, minutes. In several embodiments, transaction system 120 can require issuer Vodafone to maintain a sufficient amount of real currency in account 540 to cover the open virtual currency, Points, in all the accounts in the issuer scope of issuer Vodafone. In many embodiments, issuer Vodafone can define an account 543 for the customer Julia (the same customer having account 533 in the issuer scope of issuer Sube) within the issuer scope of Vodafone.

In several embodiments, the administrator (e.g., super user) of transaction system 120 can effectively act like an issuer of issuers, and can be responsible for injecting money into the real currency accounts (e.g., 530, 540) of the issuers for support of the open virtual currency accounts (e.g., 531, 541). In some embodiments, each account within transaction system 120 can operate in a similar or identical manner, whether it is an issuer account of a customer account, except that a super user can inject money into real currency accounts (e.g., 530, 540).

In many embodiments, exchanges can occur between open virtual currencies. Continuing with the example shown in FIG. 5, issuer Sube can send transaction unit 520 to transaction system 120 to exchange 100 points from Julia's Sube account to Julia's Vodafone account. In some examples, an exchange between accounts for different issuers can be a transaction that is not a default transaction. In a number of embodiments, transaction unit 520 can be processed in core 401 of transaction system 120, and can affect data 402 in transaction system 120. In several embodiments, account 533 can be the origin account and account 543 can be the destination account. In many embodiments, transaction unit 520 can be processed by transferring a proportional amount of real currency from the real currency account (e.g. account 530 (Sube's real currency issuer account)) associated with the issuer for the origin account (e.g., account 533 (Julia's Sube account)) to the real currency account (e.g., account 540 (Vodafone's real currency issuer account)) associated with the issuer for the destination account (e.g., account 543 (Julia's Vodafone account)). In order to determine the amount of real currency to transfer from account 530 (Sube's real currency issuer account) to account 540 (Vodafone's real currency issuer account) and to determine the amount of minutes to transfer to account 543 (Julia's Vodafone account), transaction system 120 can perform exchange calculations 550 and various actions to effectuate transaction unit 520. Specifically, transaction system 120 can perform an action 551 of decrementing 100 points from account 533 (Julia's Sube account). Based on exchange rate 532, in which 10 points is equivalent to $1, and exchange rate 542, in which 5 minutes is equivalent to $2, exchange calculations 550 can determine that 100 Points is equivalent to $10, and that $10 is equivalent to 25 minutes. As such, transaction system 120 can perform an action 552 of decrementing $10 from account 530 (Sube's real currency issuer account), an action 553 of incrementing $10 to account 540 (Vodafone's real currency issuer account), and an action 554 of incrementing 25 minutes to account 554 (Julia's Vodafone account). For example, the 250 points in account 533 can be decremented by 100 points to 150 points, the $6445 in account 530 can be decremented by $10 to $6435, the $4342 in account 540 can be incremented by $10 to $4352, and the 50 minutes in account 543 can be incremented by 25 minutes to 75 minutes.

In some embodiments, a customer can initiate an exchange transaction through an issuer of an account involved in the exchange transaction. For example, Julia can initiate the exchange transaction of transaction unit 420 through issuer Ficcy, and issuer Ficcy can send the transaction unit from issuer system 410 to transaction system 120. In other embodiments, a customer can initiate an exchange transaction directly through transaction system 120. For example, Julia can initiate the exchange transaction of transaction unit 420 through transaction system 120, such as through input interface 121 (FIG. 1). In various embodiments, each transaction unit can include an identification of a location (such as a longitude and latitude location) of where the transaction was initiated, which can be stored by transaction system 120 in database 125 (FIG. 1).

In many embodiments, transaction system 120 can provide various tools, such as through input interface 121 and/or administrative interface 124, for the issuer and/or administrator to manage, follow, and/or monitor the operations, such as obtaining account balances, adding money, extracting money, exchanging money, evaluating revenue, obtaining statistical information for the business, and/or other suitable operations. In several embodiments, transaction system 120 can provide a dashboard, such as through input interface 121 and/or administrative interface 124, which can allow real-time monitoring for evaluation of actions, such as defined actions; monitoring of transaction flows and units in real time; identifying identify the locations in which the transactions have occurred; setting financial goals for each transaction unit; and/or monitoring progress toward such goals, such as by the second. In several embodiments, transaction system 120 can provide access to issuers to data mining tools to extract information on how the business performs, which can beneficially assist the issuer to optimize business flows and to find business opportunities. For example, transaction system 120 can provide statistical information for an issuer within the issuer scope (e.g., 301 (FIG. 3)) or for an administrator within the super user scope (e.g., 302 (FIG. 3)), such as the number of transactions per second, minute, hour, day, week, month, year, ever, etc.; the amount of revenue per second, minute, hour, day, week, month, year, ever, etc.; the total number of accounts; target goals and achievement percentages; heat maps showing locations and distributions for transactions; etc.

In a number of embodiments, transaction system 120 can assist business of various types, such as loyalty, couponing, e-commerce, accounting, etc. For example, a café can use transaction system 120 to increase its sales and achieve client fidelity. By using transaction system 120, the café can create a virtual currency, which it can use to provide loyalty points to customers. The customers can redeem the obtained points in exchange for benefits in the cafeteria. Transaction system 120 can track the transactions between the cafeteria and each customer, and provide that information in variety of ways to the café. For example, the café can learn how many different customers it has and how often those customers visit the café. In many embodiments, the functionary of transaction system 120 can be provided to the café through an API, such that the café can use transaction system 120 in any customized manner desired in order to interact with its customers.

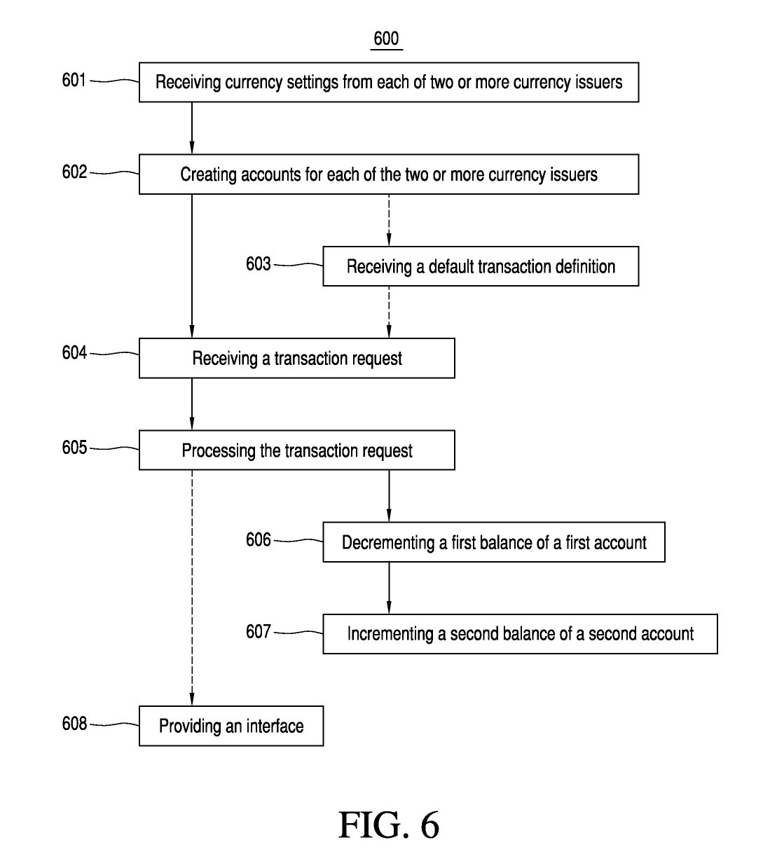

Turning ahead in the drawings, FIG. 6 illustrates a flow chart for a method 600 for facilitating transactions. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

Referring to FIG. 6, method 600 can include a block 601 of receiving currency settings from each of two or more issuers. The issuers can be similar or identical to issuers 201-202 (FIG. 2) and/or issuers 310, 320, 330, 340 (FIG. 3), and/or the issuers using issuer systems 161-163 (FIG. 1), issuer systems 410-411 (FIG. 4), and/or issuer systems 510-511 (FIG. 5). In a number of embodiments, at least a part of the currency settings can be similar or identical to currency 212 (FIG. 2), currency 216 (FIG. 2), currency 232 (FIG. 2), currency 236 (FIG. 2), currency 242 (FIG. 2), currency 245 (FIG. 2), and/or currency 248 (FIG. 2). In some embodiments, the currency settings can include an exchange rate, such as exchange rate 221 (FIG. 2), exchange rate 222 (FIG. 2), exchange rate 532 (FIG. 5), and/or exchange rate 542 (FIG. 5). In many embodiments, each of the two or more issuers can issue a different currency. In some embodiments, the currency settings for at least one of the two or more issuers can include settings for a virtual currency. For example, the virtual currency can be similar or identical to currency 232 (FIG. 2), currency 236 (FIG. 2), currency 242 (FIG. 2), currency 245 (FIG. 2), and/or currency 248 (FIG. 2). In a number of embodiments, block 601 can be performed at least in part by input interface 121 (FIG. 1), and/or administrative interface 124 (FIG. 1).

In several embodiments, method 600 also can include a block 602 of creating accounts for each of the two or more issuers. The accounts can be similar or identical to account 211 (FIG. 2), account 215 (FIG. 2), account 231 (FIG. 2), account 235 (FIG. 2), account 241 (FIG. 2), account 244 (FIG. 2), and/or account 247 (FIG. 2). In some embodiments, the accounts for each of the two or more issuers can be configured to use the currency issued by the issuer. In several embodiments, the accounts for each of the two or more issuers can include an issuer account and one or more customer accounts associated with customers of the issuer. The issuer account can be similar or identical to account 421 (FIG. 4), account 431 (FIG. 4), account 441 (FIG. 4), account 530 (FIG. 5), account 531 (FIG. 5), account 540 (FIG. 5), and/or account 541 (FIG. 5). The customer account can be similar or identical to account 422 (FIG. 4), account 432 (FIG. 4), account 442 (FIG. 4), account 533 (FIG. 5), and/or account 543 (FIG. 5). In various embodiments, balances of the accounts can be stored in a database. For example, the balances can be similar or identical to balance 213 (FIG. 2), balance 217 (FIG. 2), balance 233 (FIG. 2), balance 237 (FIG. 2), balance 243 (FIG. 2), balance 246 (FIG. 2), and/or balance 249 (FIG. 2). In several embodiments, the database can be similar or identical to database 125 (FIG. 1). In various embodiments, block 602 can be performed at least in part by input interface 121 (FIG. 1), and/or administrative interface 124 (FIG. 1).

In certain embodiments, method 600 can optionally include a block 603 of receiving a default transaction definition from at least one of the two or more issuers. In many embodiments, block 603 can be performed before block 604, described below. In some embodiments, the default transaction definition can be similar or identical to transaction unit 420 (FIG. 4), transaction unit 430 (FIG. 4), and/or transaction unit 440 (FIG. 4). In a number of embodiments, block 604 can be performed at least in part by input interface 121 (FIG. 1) and/or administrative interface 124 (FIG. 1).

In many embodiments, method 600 further can include a block 604 of receiving a transaction request. For example, in some embodiments, the transaction request can be similar or identical to transaction unit 420 (FIG. 4), transaction unit 430 (FIG. 4), transaction unit 440 (FIG. 4), and/or transaction unit 520 (FIG. 4). In some embodiments, the transaction request can include a location identifier. In some embodiments, the location identical can be included with the transaction unit to indicate where the transaction was initiated, as described above. The location identifier can include a location from which the transaction was initiated. In many embodiments, block 604 can include storing the location identifier in the database. In a number of embodiments, block 604 can be performed at least in part by input interface 121 (FIG. 1).

In several embodiments, method 500 additionally can include a block 605 of processing the transaction request. For example, the transaction request can be processed as shown in transaction flows 400 (FIG. 4) and transaction flows 500 (FIG. 5). In some embodiments, block 605 can be performed at least in part by transaction unit processor 122 (FIG. 1) using database 125 (FIG. 1).

In some embodiments, block 605 can include a block 606 of decrementing in the database a first balance of a first account. In many embodiments, the decrementing can be similar or identical to action 423 (FIG. 4), action 433 (FIG. 4), action 443 (FIG. 4), action 551 (FIG. 5), and/or action 552 (FIG. 5). In some embodiments, the first account can be configured to use a first currency issued by a first issuer of the two or more issuers.

In several embodiments, block 605 also can include a block 607 of incrementing in the database a second balance of a second account. In many embodiments, the incrementing can be similar or identical to action 424 (FIG. 4), action 434 (FIG. 4), action 444 (FIG. 4), action 553 (FIG. 5), and/or action 555 (FIG. 5). In several embodiments, the accounts can include the first account and the second account. In many embodiments, the first account can be different from the second account. In many embodiments, the second account can be configured to use a second currency issued by a second issuer of the two or more issuers. In several embodiments, the first currency can be different from the second currency. In some embodiments, the first and second account each can be a customer account of the first customer.

In several embodiments, the first account can be an issuer account and can be configured to use a first currency issued by a first issuer of the two or more issuers. In a number of embodiments, the second account can be a customer account and can be configured to use the first currency issued by the first issuer of the two or more issuers. In some embodiments, the first account can use a first virtual currency. The first virtual currency can be similar or identical to the currencies in row 230 (FIG. 2), namely currency 232 (FIG. 2) and/or currency 236 (FIG. 2); the currencies in row 240 (FIG. 2), namely currency 242 (FIG. 2), currency 245 (FIG. 2); and/or currency 248 (FIG. 2), and/or the currencies used in account 421 (FIG. 4), account 422 (FIG. 4), account 431 (FIG. 4), account 432 (FIG. 4), account 531 (FIG. 5), account 533 (FIG. 5), account 543 (FIG. 5), and/or account 541 (FIG. 5).

In some embodiments, embodiments, block 605 of processing the transaction request can include decrementing in the database the first balance of the first account according to the default transaction definition received in block 603 and incrementing in the database the second balance of the second account, according to the default transaction definition. The second account uses a second virtual currency different from the first virtual currency. The second virtual currency can be similar or identical to the currencies in row 230 (FIG. 2), namely currency 232 (FIG. 2) and/or currency 236 (FIG. 2); the currencies in row 240 (FIG. 2), namely currency 242 (FIG. 2), currency 245 (FIG. 2), and/or currency 248 (FIG. 2); and/or the currencies used in account 421 (FIG. 4), account 422 (FIG. 4), account 431 (FIG. 4), account 432 (FIG. 4), account 531 (FIG. 5), account 533 (FIG. 5), account 543 (FIG. 5), and/or account 541 (FIG. 5). In some embodiments, the first and second virtual currencies each can be open currencies having exchange rates with a real currency. For example, the first and second virtual currencies can be similar or identical to similar or identical to the currencies in row 230 (FIG. 2), namely currency 232 (FIG. 2) and/or currency 236 (FIG. 2); and/or the currencies used in account 531 (FIG. 5), account 533 (FIG. 5), account 543 (FIG. 5), and/or account 541 (FIG. 5).

In various embodiments, method 600 optionally can include a block 608 of providing an interface configured to allow each of the two or more issuers to obtain account information regarding the issuer account for the issuer and the one or more customer accounts for the issuer. For example, in many embodiments, the interface can be similar or identical to administrative interface 124 (FIG. 1). In several embodiments, the interface can be further configured to provide statistical information to each of the two or more issuers regarding the customer accounts for the issuer. In various embodiments, the statistical information can include at least one of transaction rate information or transaction location information.

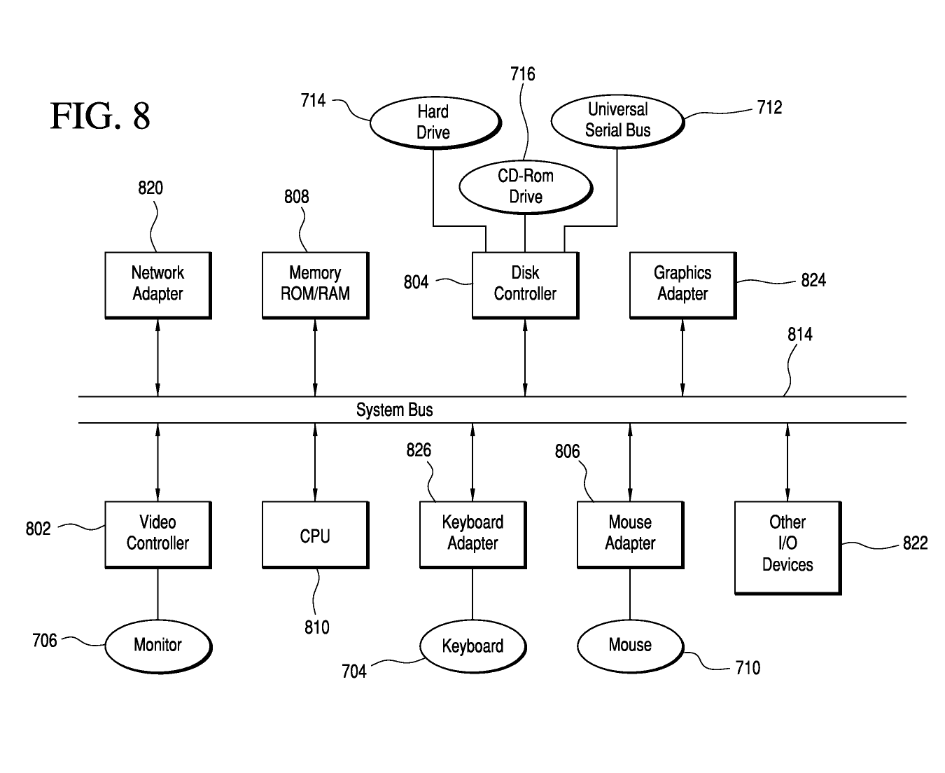

Turning ahead in the drawings, FIG. 7 illustrates a computer system 700, all of which or a portion of which can be suitable for implementing an embodiment of at least a portion of transaction system 120 (FIG. 1). Computer system 700 includes a chassis 702 containing one or more circuit boards (not shown), a USB (universal serial bus) port 712, a Compact Disc Read-Only Memory (CD-ROM) and/or Digital Video Disc (DVD) drive 716, and a hard drive 714. A representative block diagram of the elements included on the circuit boards inside chassis 702 is shown in FIG. 8. A central processing unit (CPU) 810 in FIG. 8 is coupled to a system bus 814 in FIG. 8. In various embodiments, the architecture of CPU 810 can be compliant with any of a variety of commercially distributed architecture families.

Continuing with FIG. 8, system bus 814 also is coupled to memory 808 that includes both read only memory (ROM) and random access memory (RAM). Non-volatile portions of memory storage unit 808 or the ROM can be encoded with a boot code sequence suitable for restoring computer system 700 (FIG. 7) to a functional state after a system reset. In addition, memory 808 can include microcode such as a Basic Input-Output System (BIOS). In some examples, the one or more memory storage units of the various embodiments disclosed herein can comprise memory storage unit 808, a USB-equipped electronic device, such as, an external memory storage unit (not shown) coupled to universal serial bus (USB) port 712 (FIGS. 7-8), hard drive 714 (FIGS. 7-8), and/or CD-ROM or DVD drive 716 (FIGS. 7-8). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 810.

In the depicted embodiment of FIG. 8, various I/O devices such as a disk controller 804, a graphics adapter 824, a video controller 802, a keyboard adapter 826, a mouse adapter 806, a network adapter 820, and other I/O devices 822 can be coupled to system bus 814. Keyboard adapter 826 and mouse adapter 806 are coupled to a keyboard 604 (FIGS. 7 and 8) and a mouse 710 (FIGS. 7 and 8), respectively, of computer system 700 (FIG. 7). While graphics adapter 824 and video controller 802 are indicated as distinct units in FIG. 8, video controller 802 can be integrated into graphics adapter 824, or vice versa in other embodiments. Video controller 802 is suitable for refreshing a monitor 706 (FIGS. 7 and 8) to display images on a screen 708 (FIG. 7) of computer system 700 (FIG. 7). Disk controller 804 can control hard drive 714 (FIGS. 7 and 8), USB port 712 (FIGS. 7 and 8), and CD-ROM or DVD drive 716 (FIGS. 7 and 8). In other embodiments, distinct units can be used to control each of these devices separately.

In some embodiments, network adapter 820 can comprise and/or be implemented as a WNIC (wireless network interface controller) card (not shown) plugged or coupled to an expansion port (not shown) in computer system 700 (FIG. 7). In other embodiments, the WNIC card can be a wireless network card built into computer system 700 (FIG. 7). A wireless network adapter can be built into computer system 700 (FIG. 7) by having wireless communication capabilities integrated into the motherboard chipset (not shown), or implemented via one or more dedicated wireless communication chips (not shown), connected through a PCI (peripheral component interconnector) or a PCI express bus of computer system 700 (FIG. 7) or USB port 712 (FIG. 7). In other embodiments, network adapter 820 can comprise and/or be implemented as a wired network interface controller card (not shown).

Although many other components of computer system 700 (FIG. 7) are not shown, such components and their interconnection are well known to those of ordinary skill in the art. Accordingly, further details concerning the construction and composition of computer system 700 (FIG. 7) and the circuit boards inside chassis 702 (FIG. 7) need not be discussed herein.

When computer system 700 in FIG. 7 is running, program instructions stored on a USB drive in USB port 712, on a CD-ROM or DVD in CD-ROM and/or DVD drive 716, on hard drive 714, or in memory 808 (FIG. 8) are executed by CPU 810 (FIG. 8). A portion of the program instructions, stored on these devices, can be suitable for carrying out all or at least part of the techniques described herein.

Although computer system 700 is illustrated as a desktop computer in FIG. 7, there can be examples where computer system 700 may take a different form factor while still having functional elements similar to those described for computer system 700. In some embodiments, computer system 700 may comprise a single computer, a single server, or a cluster or collection of computers or servers, or a cloud of computers or servers. Typically, a cluster or collection of servers can be used when the demand on computer system 700 exceeds the reasonable capability of a single server or computer. In certain embodiments, computer system 700 may comprise a portable computer, such as a laptop computer. In certain other embodiments, computer system 700 may comprise a mobile device, such as a smartphone. In certain additional embodiments, computer system 700 may comprise an embedded system.

Although the transaction system has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIG. 6 may include different procedures, processes, and/or activities and be performed by many different modules, in many different orders.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for facilitating transactions, the method being implemented via execution of computer instructions configured to run at one or more processing modules and configured to be stored at one or more non-transitory memory storage modules, the method comprising:
receiving currency settings from each of two or more issuers, wherein:
each of the two or more issuers issues a different currency; and
the currency settings for at least one of the two or more issuers comprise settings for a virtual currency;
creating accounts for each of the two or more issuers, wherein:
the accounts for each of the two or more issuers are configured to use the currency issued by the issuer;
the accounts for each of the two or more issuers comprise:
an issuer account; and
one or more customer accounts associated with customers of the issuer; and
balances of the accounts are stored in a database;
receiving a transaction request; and
processing the transaction request, comprising:
decrementing in the database a first balance of a first account; and
incrementing in the database a second balance of a second account, wherein:
the accounts comprise the first account and the second account; and
the first account is different from the second account.

2. The method of claim 1, wherein:
the first account is configured to use a first currency issued by a first issuer of the two or more issuers;
the second account is configured to use a second currency issued by a second issuer of the two or more issuers;
the first currency is different from the second currency.

3. The method of claim 2, wherein:
the first account is a customer account of a first customer; and
the second account is a customer account of the first customer.

4. The method of claim 1, wherein:
the first account is an issuer account and is configured to use a first currency issued by a first issuer of the two or more issuers; and
the second account is a customer account and is configured to use the first currency issued by the first issuer of the two or more issuers.

5. The method of claim 1 further comprising:
before receiving the transaction request, receiving a default transaction definition from at least one of the two or more issuers,
wherein:
processing the transaction request comprises:
decrementing in the database the first balance of the first account according to the default transaction definition; and
incrementing in the database the second balance of the second account, according to the default transaction definition.

6. The method of claim 1, wherein receiving the transaction request comprises:
receiving the transaction request such that the transaction request comprises a location identifier, the location identifier comprising a location from which the transaction was initiated; and
storing the location identifier in the database.

7. The method of claim 1, wherein the:
the first account uses a first virtual currency;
the second account uses a second virtual currency different from the first virtual currency; and
the first and second virtual currencies are each open currencies having exchange rates with a real currency.

8. The method of claim 1 further comprising:
providing an interface configured to allow each of the two or more issuers to obtain account information regarding the issuer account for the issuer and the one or more customer accounts for the issuer.

9. The method of claim 8, wherein:
the interface is further configured to provide statistical information to each of the two or more issuers regarding the customer accounts for the issuer.

10. The method of claim 9, wherein:
the statistical information comprises at least one of transaction rate information or transaction location information.

11. A system for facilitating transactions, the system comprising:
one or more processing modules; and
one or more non-transitory memory storage modules storing computing instructions configured to run on the one or more processing modules and perform the acts of:
receiving currency settings from each of two or more issuers, wherein:
each of the two or more issuers issues a different currency; and
the currency settings for at least one of the two or more issuers comprise settings for a virtual currency;
creating accounts for each of the two or more issuers, wherein:
the accounts for each of the two or more issuers are configured to use the currency issued by the issuer;
the accounts for each of the two or more issuers comprise:
an issuer account; and
one or more customer accounts associated with customers of the issuer; and
balances of the accounts are stored in a database;
receiving a transaction request; and
processing the transaction request, comprising:
decrementing in the database a first balance of a first account; and
incrementing in the database a second balance of a second account,
wherein:
the accounts comprise the first account and the second account; and
the first account is different from the second account.

12. The system of claim 11, wherein:
the first account is configured to use a first currency issued by a first issuer of the two or more issuers;
the second account is configured to use a second currency issued by a second issuer of the two or more issuers;
the first currency is different from the second currency.

13. The system of claim 12, wherein:
the first account is a customer account of a first customer; and
the second account is a customer account of the first customer.

14. The system of claim 11, wherein:
the first account is an issuer account and is configured to use a first currency issued by a first issuer of the two or more issuers; and
the second account is a customer account and is configured to use the first currency issued by the first issuer of the two or more issuers.

15. The system of claim 11, wherein:
the computing instructions are further configured to perform the act of:
before receiving the transaction request, receiving a default transaction definition from at least one of the two or more issuers; and
processing the transaction request comprises:
decrementing in the database the first balance of the first account according to the default transaction definition; and
incrementing in the database the second balance of the second account, according to the default transaction definition.

16. The system of claim 11, wherein receiving the transaction request comprises:
receiving the transaction request such that the transaction request comprises a location identifier, the location identifier comprising a location from which the transaction was initiated; and
storing the location identifier in the database.

17. The system of claim 1, wherein the:
the first account uses a first virtual currency;
the second account uses a second virtual currency different from the first virtual currency; and
the first and second virtual currencies are each open currencies having exchange rates with a real currency.

18. The system of claim 11, wherein the computing instructions are further configured to perform the act of:
providing an interface configured to allow each of the two or more issuers to obtain account information regarding the issuer account for the issuer and the one or more customer accounts for the issuer.

19. The system of claim 18, wherein:
the interface is further configured to provide statistical information to each of the two or more issuers regarding the customer accounts for the issuer.

20. The system of claim 19, wherein:
the statistical information comprises at least one of transaction rate information or transaction location information.
